(19) United States
(12) Patent Application Publication
(10) Pub. No.: US 2026/0099967 A1
(43) Pub. Date: Apr. 9, 2026

(54) MODIFYING DIGITAL IMAGES FROM TEXT VIA MULTI-REGION LOCALIZED STYLE TRANSFER

(71) Applicant: Adobe Inc., San Jose, CA (US)

(72) Inventors: Silky Singh, Bisrakh Jalalpur (IN); Surgan Jandial, Jammu (IN); Simra Shahid, Noida (IN); Abhinav Java, Noida (IN)

(21) Appl. No.: 18/906,870

(22) Filed: Oct. 4, 2024

(51) Int. Cl. G06T 11/60; G06F 3/04845; G06T 7/10; G06V 10/25

(52) U.S. Cl. CPC G06T 11/60; G06F 3/04845; G06T 7/10; G06V 10/25

(57) ABSTRACT

The present disclosure relates to systems, methods, and non-transitory computer-readable media that modifies regions of a digital image via localized style transfer. For example, in some embodiments, the disclosed systems receive a natural language text input for modifying a digital image and determine, from the natural language text input, a first style for modifying a first region of the digital image and a second style for modifying a second region of the digital image. Additionally, the disclosed systems modify, using a multi-region style transfer neural network, the digital image by incorporating the first style within the first region and incorporating the second style within the second region. Further, the disclosed systems provide the modified digital image for display on a graphical user interface of a client device.

### BACKGROUND

Recent years have seen significant advancement in hardware and software platforms for editing digital images. Indeed, as the use of digital images has become increasingly ubiquitous, systems have developed to facilitate the manipulation of the content within such digital images. In particular, many systems offer various tools that enable various changes to the content of digital images. Some systems, for example, offer tools for modifying the stylistic appearance of a digital image based on a style portrayed by another digital image or a style indicated by a text input.

### SUMMARY

One or more embodiments described herein provide benefits and/or solve one or more problems in the art with systems, methods, and non-transitory computer-readable media that flexibly perform localized, text-based style transfer to modify various regions of a digital image using various styles. For instance, in one or more embodiments, a system implements an end-to-end pipeline that integrates spatial nuances from textual style descriptions into the style transfer process. To illustrate, in some cases, the system extracts region-style correspondences from a prompt including natural language text. The system additionally grounds each of the extracted regions in the input image, resulting in a segmentation mask per region. Further, with the segmentation masks, the system iteratively performs local style transfer within each region in the input image, producing the final stylized output image. In this manner, the system flexibly localizes the style transfer process such that a single text input leads to a modified image having multiple styles incorporated within multiple regions.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a multi-region editing system operates in accordance with one or more embodiments;

FIG. 2 illustrates the multi-region editing system incorporating different styles into different regions of a digital image via localized style transfer in accordance with one or more embodiments;

FIG. 3 illustrates the multi-region editing system generating a style-region mapping from natural language text input in accordance with one or more embodiments;

FIG. 4 illustrates the multi-region editing system grounding regions extracted from natural language text input in a digital image in accordance with one or more embodiments;

FIG. 5 illustrates the multi-region editing system modifying a region of a digital image using a multi-region style transfer neural network in accordance with one or more embodiments;

FIG. 6 illustrates the multi-region editing system modifying multiple regions of a digital image in accordance with one or more embodiments;

FIG. 7 illustrates an example schematic diagram of a multi-region editing system in accordance with one or more embodiments;

FIG. 8 illustrates a flowchart of a series of acts for modifying multiple regions of a digital image via localized style transfer in accordance with one or more embodiments; and

FIG. 9 illustrates a block diagram of an exemplary computing device in accordance with one or more embodiments.

### DETAILED DESCRIPTION

One or more embodiments described herein include a multi-region editing system that flexibly modifies multiple regions of a digital image via localized style transfer based on a single natural language text input. To illustrate, in one or more embodiments, the multi-region editing system implements an end-to-end pipeline that involves determining correspondences between regions and styles indicated in the natural language text input, generating segmentation masks for portions of the digital image that correspond to the indicated regions, and incorporating the indicated style for each region using the generated segmentation mask. In some embodiments, the multi-region editing system uses one or more machine learning models to implement the pipeline.

To illustrate, in one or more embodiments, the multi-region editing system receives natural language text input for modifying a digital image. The multi-region editing system determines, from the natural language text input, a first style for modifying a first region of the digital image and a second style for modifying a second region of the digital image. Using a multi-region style transfer neural network, the multi-region editing system modifies the digital image by incorporating the first style within the first region and incorporating the second style within the second region. The multi-region editing system further provides the modified digital image for display on a graphical user interface of a client device (e.g., the client device that submitted the natural language text input).

As just indicated, in one or more embodiments, the multi-region editing system modifies a digital image via localized style transfer based on a single natural language text input. Indeed, in some embodiments, the multi-region editing system modifies multiple regions of a digital image to incorporate corresponding styles in accordance with a single natural language text input. In particular, in some cases, the multi-region editing system modifies each region indicated by the natural language text input to incorporate a different style.

As previously mentioned, in one or more embodiments, the multi-region editing system implements an end-to-end pipeline to modify a digital image via localized style transfer. Thus, in some cases, the multi-region editing system receives natural language text input indicating various modifications to be made to a digital image, parses the text to understand each modification individually, and implements each modification to generate an editing result.

To illustrate, in one or more embodiments, the multi-region editing system implements the end-to-end pipeline by determining correspondences between regions and styles indicated within the natural language text input. For instance, in some embodiments, the multi-region editing system generates a style-region mapping that maps the indicated regions to the indicated styles.

In some cases, the multi-region editing system also grounds the regions indicated by the natural language text input in the digital image. In particular, in certain embodiments, the multi-region editing system determines which regions (e.g., content portions) of the digital image correspond to those regions indicated within the text of the natural language text input. In some instances, the multi-region editing system generates a segmentation mask for the determined regions (e.g., content portions) of the digital image.

Further, in one or more embodiments, the multi-region editing system modifies the digital image to incorporate the styles indicated by the natural language text input within their corresponding regions. In some implementations, the multi-region editing system modifies the digital image using a neural network. For instance, in some cases, the multi-region editing system uses a neural network to modify each region individually over multiple iterations. To illustrate, in some cases, the multi-region editing system uses the neural network to modify a first region of the digital image over a first set of iterations and modify a second region of the digital image over a subsequent set of iterations. In certain instances, the multi-region editing system updates the network parameters throughout each set of iterations using various loss functions.

The multi-region editing system provides advantages over conventional systems. Indeed, conventional style transfer systems suffer from several technological shortcomings that result in in inflexible and inefficient operation. To illustrate, many conventional systems are inflexible in that they are limited in how they modify digital images via style transfer. For instance, conventional systems—whether performing image-based or text-based style transfer—are typically restricted to applying a single style to an entire image. While some conventional systems do enable localized style transfer in which a particular region of a digital image is modified, such systems are typically limited to modifying a single region. Further, such systems often curate the region that is editable or otherwise assume that the user input is targeting a particular region. Thus, these systems often fail to accommodate complex style transfer inputs in which multiple regions are targeted for modification using multiple styles.

Additionally, many conventional style transfer systems fail to operate efficiently. For example, many conventional systems perform style transfer using a neural network that requires pre-training to learn network parameters that produce the desired editing results. Such pre-training, however, is often computationally demanding, consuming significant amounts of resources—such as processing time (e.g., on the order of hours) and power—to complete.

One or more embodiments of the multi-region editing system operate with improved flexibility when compared to conventional systems. For instance, by modifying multiple regions of a digital image to incorporate multiple different styles, the multi-region editing system flexibly performs more complex style transfers. Further, by implementing an end-to-end pipeline that includes parsing natural language text input to identify regions and styles indicating therein and modifying a digital image based on the parsing, the multi-region editing system flexibly accommodates complex style transfer inputs in which multiple regions are targeted for modification using multiple styles.

Additionally, one or more embodiments of the multi-region editing system operate with improved efficiency when compared to conventional systems. For example, by learning the network parameters used to modify a digital image at inference time, the multi-region editing system avoids the pre-training required under many conventional systems, decreasing the amount of computing resources consumed to implement style transfer modifications. For instance, in some cases, the multi-region editing system modifies a digital image in a few seconds compared to the hours that is often required to pre-train a neural network under many conventional systems.

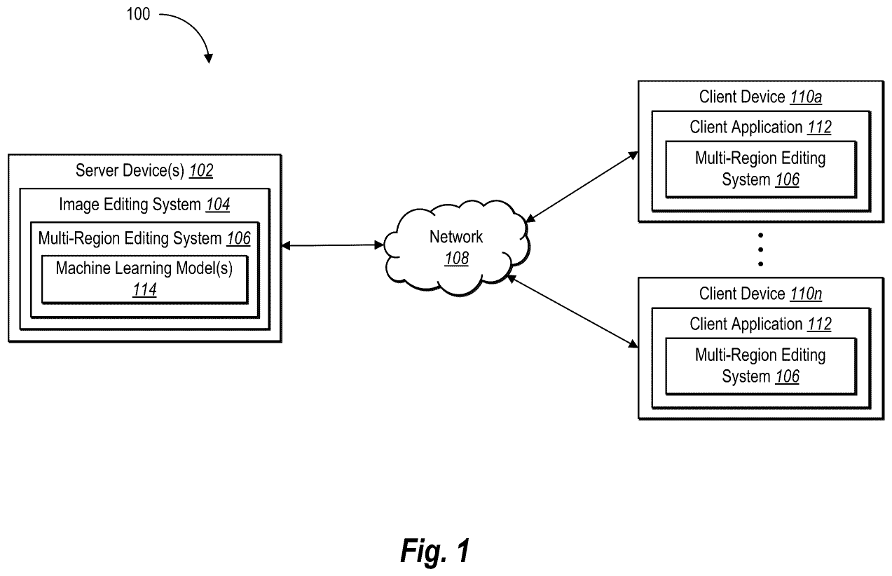

Additional detail regarding the multi-region editing system will now be provided with reference to the figures. For example, FIG. 1 illustrates a schematic diagram of an exemplary system 100 in which a multi-region editing system 106 operates. As illustrated in FIG. 1, the system 100 includes a server device(s) 102, a network 108, and client devices 110a-110n.

Although the system 100 of FIG. 1 is depicted as having a particular number of components, the system 100 is capable of having any number of additional or alternative components (e.g., any number of server devices, client devices, or other components in communication with the multi-region editing system 106 via the network 108). Similarly, although FIG. 1 illustrates a particular arrangement of the server device(s) 102, the network 108, and the client devices 110a-110n, various additional arrangements are possible.

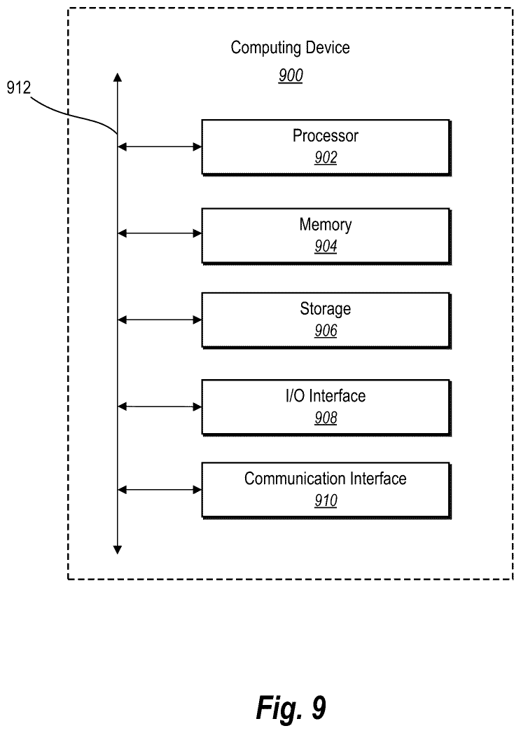

The server device(s) 102, the network 108, and the client devices 110a-110n are communicatively coupled with each other either directly or indirectly (e.g., through the network 108 discussed in greater detail below in relation to FIG. 9). Moreover, the server device(s) 102 and the client devices 110a-110n include one or more of a variety of computing devices (including one or more computing devices as discussed in greater detail with relation to FIG. 9).

As mentioned above, the system 100 includes the server device(s) 102. In one or more embodiments, the server device(s) 102 generates, stores, receives, and/or transmits data, including digital images and/or modified digital images. In one or more embodiments, the server device(s) 102 comprises one or more data server devices. In some implementations, the server device(s) 102 comprises one or more communication server devices or one or more web-hosting server devices.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server device(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to modify various regions of a digital image via localized style transfer based on natural language text input.

In one or more embodiments, the client devices 110a-110n include computing devices that are capable of accessing, modifying, and/or storing digital images, including modified digital images. For example, in some embodiments, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images, including modified digital images. For example, in some embodiments, the client application 112 includes a software application installed on the client devices 110a-110n. Additionally, or alternatively, the client application 112 includes a web browser or other application that accesses a software application hosted on the server device(s) 102 (and supported by the image editing system 104).

To provide an example implementation, in some embodiments, the multi-region editing system 106 on the server device(s) 102 supports the multi-region editing system 106 on the client device 110n. For instance, in some cases, the multi-region editing system 106 on the server device(s) 102 generates or learns parameters for the one or more machine learning models 114. The multi-region editing system 106 then, via the server device(s) 102, provides the one or more machine learning models 114 to the client device 110n. In other words, the client device 110n obtains (e.g., downloads) the one or more machine learning models 114 (e.g., with any learned parameters) from the server device(s) 102. Once downloaded, the multi-region editing system 106 on the client device 110n uses the one or more machine learning models 114 to modify various regions of a digital image via localized style transfer independent from the server device(s) 102.

In alternative implementations, the multi-region editing system 106 includes a web hosting application that allows the client device 110n to interact with content and services hosted on the server device(s) 102. To illustrate, in one or more implementations, the client device 110n accesses a software application supported by the server device(s) 102. The client device 110n provides input to the server device(s) 102, such as a digital image and natural language text input. In response, the multi-region editing system 106 on the server device(s) 102 modifies various regions of the digital image using various styles in accordance with the natural language text input. The server device(s) 102 then provides the modified digital image to the client device 110n.

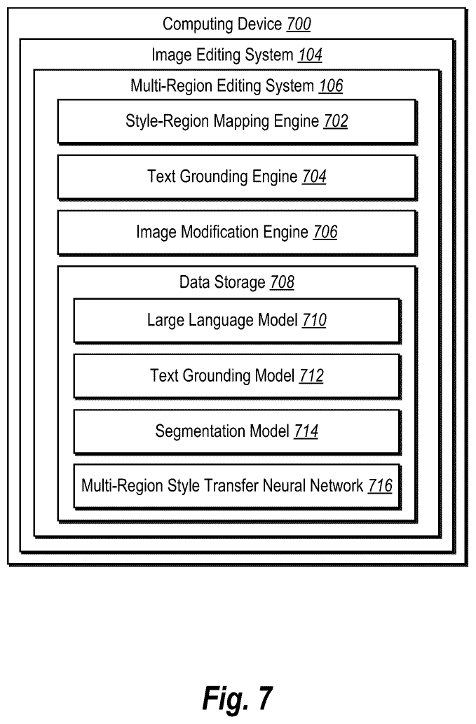

Indeed, the multi-region editing system 106 is able to be implemented in whole, or in part, by the individual elements of the system 100. Indeed, although FIG. 1 illustrates the multi-region editing system 106 being implemented with regard to the server device(s) 102, different components of the multi-region editing system 106 are able to be implemented by a variety of devices within the system 100. For example, one or more (or all) components of the multi-region editing system 106 are implemented by a different computing device (e.g., one of the client devices 110a-110n) or a separate server device from the server device(s) 102 hosting the image editing system 104. Indeed, as shown in FIG. 1, the client devices 110a-110n include the multi-region editing system 106. Example components of the multi-region editing system 106 will be described below with regard to FIG. 7.

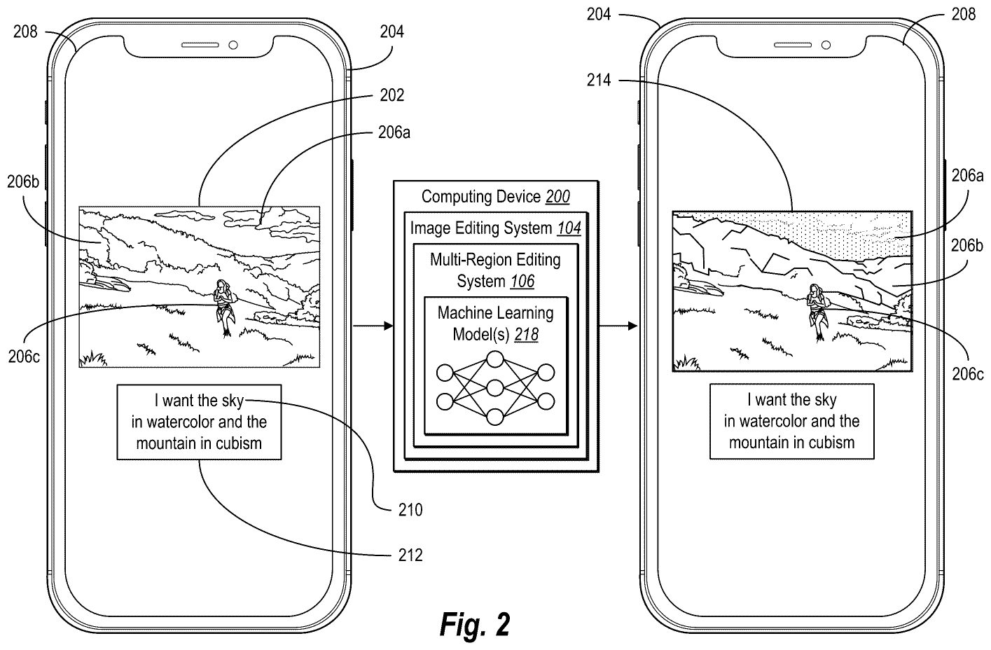

As mentioned, in one or more embodiments, the multi-region editing system 106 modifies multiple regions of a digital image using multiple styles via localized style transfer. In particular, the multi-region editing system 106 incorporates different styles into different regions of a digital image in accordance with natural language text input. FIG. 2 illustrates the multi-region editing system 106 incorporating different styles into different regions of a digital image via localized style transfer in accordance with one or more embodiments.

In one or more embodiments, a region of a digital image includes a portion of a digital image. In particular, in some embodiments, a region of a digital image includes a distinct portion of content portrayed within a digital image. Indeed, in some cases, a region (or image region) includes a distinct portion of content that is identifiable separately from other portions of content within the digital image. In many instances, a region includes a group of pixels that, together, portray the distinct portion of content separately from the portrayal of other pixels. For example, in some instances, a region includes an object (e.g., a person or part of a person or an item or part of an item). In certain embodiments, a region includes portion of a landscape portrayed in a digital image (e.g., a mountain, a river, a lake, a pathway, a field, or the sky). In some implementations, a region of a digital image more generally includes a portion of the digital image that is identifiable through some label (e.g., “the bridge”) or other description (e.g., “the area of the field between the tree and the hill”).

In one or more embodiments, a style (or image style) includes a visual appearance of a digital image or at least a region therein. In particular, in some embodiments, a style includes one or more visual and/or aesthetic characteristics that contribute to an overall look of a digital image or at least a region therein. For instance, in some cases, a style refers to the inclusion or omission of an object within a region of a digital image. In some implementations, a style includes one or more colors (e.g., a color palette), lighting, shadowing, texture, detail level, shape, form, perspective, depth, one or more brush stroke or line work characteristics, mood, emotion, and/or other visual characteristics (e.g., blurring, filtering, or other post-processing effects). Thus, in some cases, a style includes one or more visual characteristics that are identifiable through some label (e.g., “cubism”) or other description (e.g., “darker shadows”).

As shown in FIG. 2, the multi-region editing system 106 (operating on the computing device) receives a digital image 202 to be modified. In particular, the multi-region editing system 106 receives the digital image 202 from a client device 204. FIG. 2 shows the client device 204 portraying the digital image 202 within a graphical user interface 208. In some cases, the multi-region editing system 106 provides the digital image 202 for display.

Indeed, in some cases, the multi-region editing system 106 receives the digital image 202 from a computing device (e.g., the client device 204) that is external to the computing device (e.g., the computing device 200) upon which the multi-region editing system 106 operates. In some embodiments, however, the multi-region editing system 106 receives the digital image 202 from another source within the computing device upon which the multi-region editing system 106 operates. For instance, in some cases, the multi-region editing system 106 retrieves or receives the digital image 202 from an internal storage of the computing device 200 or from another system operating on the computing device 200.

As shown in FIG. 2, the digital image 202 portrays multiple regions. For instance, the digital image 202 portrays regions 206a-206c in addition to others. The number of regions portrayed in a digital image varies in various implementations. Further, the portions of a digital image included in a region varies in various embodiments. For instance, in some cases, the clouds of the digital image 202 are included within the region 206a having the sky. In some embodiments, however, the clouds are identified as a separate region from the region 206a having the sky. Further, in certain cases, each cloud is identified as a separate region.

As further shown in FIG. 2, the multi-region editing system 106 receives natural language text input 210 from the client device 204. For instance, in some cases, the multi-region editing system 106 receives the natural language text input 210 via a text box 212 portrayed within the graphical user interface 208. In some cases, the multi-region editing system 106 provides the text box 212 for display and detects user input corresponding to the natural language text input 210 through the text box 212.

In one or more embodiments, natural language text input includes a text input in the form of natural language. In particular, in some embodiments, natural language text input includes a free-form text input composed of natural language text. In some instances, natural language text input includes (e.g., describes) an editing request or otherwise provides instructions for modifying a digital image. For instance, in some cases, natural language text input indicates one or more regions of a digital image to be modified and one or more corresponding styles to use in modifying the region(s). Indeed, in some implementations, natural language text input indicates that the digital image is to be modified using multiple local edits. In particular, in certain cases, natural language text input indicates the local edits are to be made via multiple style transfers.

As illustrated in FIG. 2, the natural language text input 210 includes a plurality of text segments. In one or more embodiments, a text segment includes a portion of text. In particular, in some embodiments, a text segment includes one or more characters of text. For instance, in some cases, a text segment includes a letter, a word, or a group of words. For example, a text segment includes a sentence, phrase, label, or description in some instances.

FIG. 2 illustrates the natural language text input 210 having a plurality of text segments indicating regions of the digital image 202 to modify and corresponding styles to use in modifying those regions. In particular, the natural language text input 210 includes a first text segment (e.g., “the sky”) indicating the region 206a, a second text segment (e.g., “watercolor”) indicating a first style to use in modifying the region 206a, a third text segment (e.g., “the mountain”) indicating the region 206b, and a fourth text segment (e.g., “cubism”) indicating a second style to use in modifying the region 206b. It should be understood, however, that various numbers of regions and styles are included in natural language text input in various implementations.

As further illustrated in FIG. 2, the multi-region editing system 106 generates a modified digital image 214 from the digital image 202. In particular, the multi-region editing system 106 generates the modified digital image 214 by modifying the regions 206a-206b of the digital image 202 in accordance with the natural language text input 210. Indeed, as indicated, the multi-region editing system 106 modifies the region 206a to incorporate the first style and modifies the region 206b to incorporate the second style based on the natural language text input 210. Thus, the multi-region editing system 106 modifies multiple regions of the digital image 202 based on a single string of text (i.e., the natural language text input 210) indicating a plurality of regions to modify and a plurality of styles for modifying the plurality of regions.

As further indicated, the multi-region editing system 106 does not modify the region 206c as the natural language text input 210 does not include text segments for modifying the region 206c. In other words, the multi-region editing system 106 maintains an initial style of the region 206c due to its omission from the natural language text input 210.

As illustrated by FIG. 2, the multi-region editing system 106 provides the modified digital image 214 for display on the client device 204 (e.g., for display within the graphical user interface 208 of the client device 204). Indeed, in some cases, the multi-region editing system 106 provides the modified digital image 214 for display on the same computing device from which the digital image 202 was received. In some cases, the multi-region editing system 106 provides the modified digital image 214 for display on another computing device.

As further illustrated, the multi-region editing system 106 uses one or more machine learning models 218 to generate the modified digital image 214 from the digital image 202 in accordance with the natural language text input 210. In one or more embodiments, a machine learning model includes a computer-implemented model that is tunable (e.g., trainable) based on inputs to approximate unknown functions. In particular, in some embodiments, a machine learning model includes a model that uses algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), association rule learning, inductive logic programming, support vector learning, Bayesian network, regression-based model (e.g., censored regression), principal component analysis, or a combination thereof.

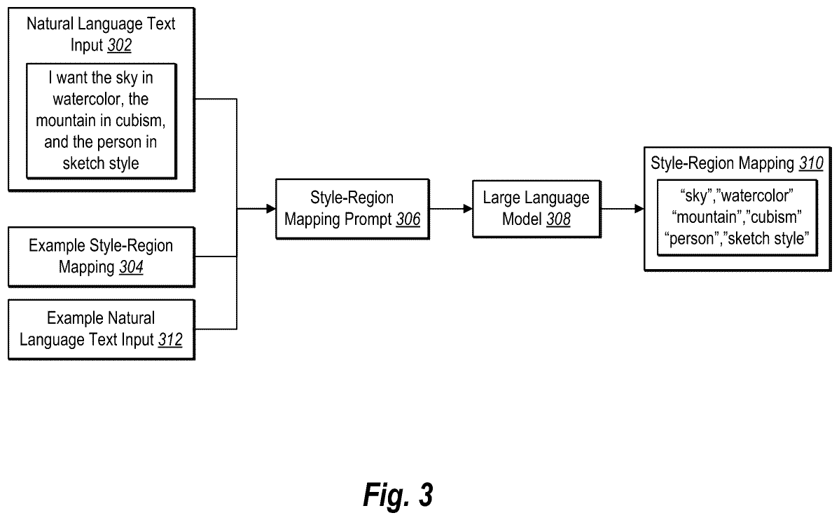

As previously mentioned, in one or more embodiments, the multi-region editing system 106 determines correspondences between regions and styles indicated in natural language text input. In particular, the multi-region editing system 106 generates a style-region mapping from natural language text input. FIG. 3 illustrates the multi-region editing system 106 generating a style-region mapping from natural language text input in accordance with one or more embodiments.

In one or more embodiments, a style-region mapping includes a mapping that indicates associations between regions and styles indicated in natural language text input. In particular, in some embodiments, a style-region mapping includes a mapping of regions of a digital image to be modified and corresponding styles to be used in modifying those regions based on natural language text input. For instance, in some cases, a style-region mapping maps a text segment indicating a region of a digital image to be modified to a text segment indicating a style to be used in modifying the region.

As shown in FIG. 3, the multi-region editing system 106 generates a style-region mapping 310 from natural language text input 302. As shown, the natural language text input 302 includes multiple text segments (e.g., “sky,” “mountain,” and “person”) that identify different regions of a digital image to modify. Further, the natural language text input 302 includes multiple additional text segments (e.g., “watercolor,” “cubism,” and “sketch style”) that indicate corresponding styles to use in modifying the indicated regions.

As further shown, the multi-region editing system 106 uses a large language model 308 to generate the style-region mapping 310 from the natural language text input 302. In one or more embodiments, a large language model includes a computer-implemented machine learning model trained to comprehend and generate human language text. In particular, in some embodiments, a large language model includes a neural network (e.g., a deep neural network) with many parameters trained on large quantities of data (e.g., unlabeled text) using a particular learning technique (e.g., self-supervised learning). For example, in some cases, a large language model includes parameters trained to generate natural language text output from natural language text input. For instance, in certain instances, the multi-region editing system 106 uses a large language model to generate natural language text output that provides a style-region mapping based on natural language text input that indicates regions of a digital image to modify and styles to use in modifying those regions. In some cases, a large language model implements a deep transformer neural network architecture. Some examples of large language models include, but are not limited to, chat generative pre-trained transformer (Chat GPT), Gemini, and Large Language Model Meta AI (LLaMA).

As illustrated in FIG. 3, the multi-region editing system 106 uses the large language model 308 to generate the style-region mapping 310 from a style-region mapping prompt 306. In one or more embodiments, a style-region mapping prompt 306 includes a prompt for generating a style-region mapping. In particular, in some embodiments, a style-region mapping prompt includes a large language model prompt for generating a style-region mapping. For instance, in certain cases, a style-region mapping prompt includes an input provided to a large language model to cause the large language model to generate an output. In some instances, style-region mapping prompt includes natural language text that provides instructions or guidance with respect to the output that is to be generated by the large language model.

Indeed, as shown in FIG. 3, the multi-region editing system 106 generates the style-region mapping prompt 306 from the natural language text input 302. For instance, in some cases, the multi-region editing system 106 includes the natural language text input 302 within the style-region mapping prompt 306 verbatim. In some instances, the multi-region editing system 106 modifies or otherwise generates content from the natural language text input 302 for inclusion within the style-region mapping prompt 306.

Additionally, as shown, the multi-region editing system 106 further generates the style-region mapping prompt 306 from an example style-region mapping 304 and an example natural language text input 312. In one or more embodiments, an example style-region mapping includes a style-region mapping that corresponds to an example natural language text input. Indeed, in some embodiments, an example style-region mapping includes a style-region mapping that maps regions indicated in the example natural language text input to corresponding styles indicated therein. To illustrate, in some cases, an example style-region mapping includes a style-region mapping generated by a large language model from corresponding example natural language text input. In some instances, the example natural language text input and corresponding example style-region mapping are created (e.g., designed) from user input.

In one or more embodiments, the multi-region editing system 106 includes the example style-region mapping 304 and/or the example natural language text input 312 within the style-region mapping prompt 306 verbatim. In some instances, the multi-region editing system 106 modifies or otherwise generates content from the example style-region mapping 304 and/or the example natural language text input 312 for inclusion within the style-region mapping prompt 306.

In certain embodiments, the multi-region editing system 106 uses the example style-region mapping 304 and the example natural language text input 312 to provide an example of the output to be generated from the natural language text input 302 by the large language model 308. For instance, in some embodiments, the multi-region editing system 106 uses the example style-region mapping 304 and the example natural language text input 312 to indicate the portions (e.g., text segments) of the natural language text input 302 to be focused on, extracted, or otherwise analyzed by the large language model 308 in generating the style-region mapping 310. In some cases, the multi-region editing system 106 uses the example style-region mapping 304 to indicate a format with which the large language model 308 is to generate the style-region mapping 310.

In some embodiments, the multi-region editing system 106 generates the style-region mapping prompt 306 using multiple example natural language text inputs and multiple corresponding example style-region mappings.

Though not shown in FIG. 3, in some cases, the multi-region editing system 106 includes additional content within the style-region mapping prompt 306. For example, in some cases, the multi-region editing system 106 includes one or more guardrails that are intended to prevent the large language model 308 from exhibiting certain flagged behavior. To illustrate, in some embodiments, the multi-region editing system 106 includes instructions prohibiting the large language model 308 from generating a long form output that describes or otherwise explains how the natural language text input 302 maps regions and styles. Additionally, in some embodiments, the multi-region editing system 106 includes instructions prohibiting the large language model 308 from generating a program for creating or using the style-region mapping 310. Thus, in certain cases, the multi-region editing system 106 configures the style-region mapping prompt 306 to cause the large language model 308 to generate a particular output having a particular format.

Indeed, as shown in FIG. 3, the multi-region editing system 106 uses the large language model 308 to generate the style-region mapping 310 based on the style-region mapping prompt 306. As further shown, the style-region mapping 310 includes a particular format in which a region is indicated and a style for the region follows after some punctuation. Indeed, in some cases, the style-region mapping 310 includes a python dictionary format. It should be understood, however, that various formats are used in various implementations.

Thus, in one or more embodiments, the multi-region editing system 106 generates the style-region mapping 310 by using the large language model 308 to parse the natural language text input 302, extracting regions and corresponding styles indicated therein. In particular, the multi-region editing system 106 uses the large language model 308 to extract text segments indicating the regions and styles from the large language model 308.

By parsing natural language text input to generate a style-region mapping, the multi-region editing system 106 offers improved flexibility when compared to conventional systems. In particular, the multi-region editing system 106 flexibly analyzes natural language text input to identify multiple different regions of a digital image indicated therein and corresponding styles to be used in modifying the regions. Thus, the multi-region editing system 106 implements a flexible end-to-end text-based style transfer process in which a single text input indicating multiple regions and corresponding styles is used to modify a digital image locally in various regions.

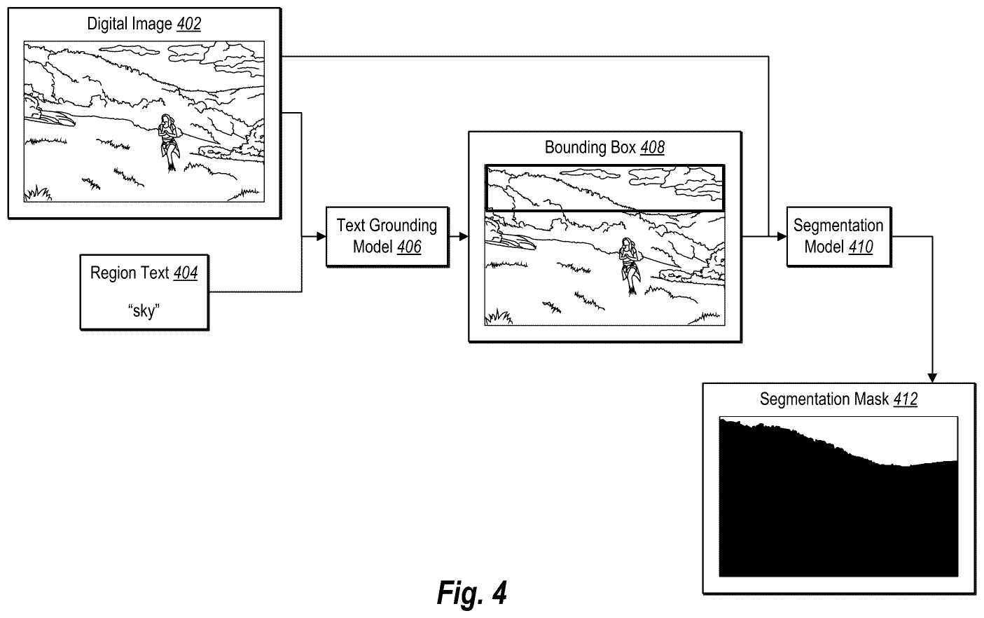

As previously discussed, the multi-region editing system 106 grounds each region extracted from natural language text input in the digital image to be modified. In particular, the multi-region editing system 106 grounds each text segment indicating (e.g., identifying or labeling) a region in the digital image. FIG. 4 illustrates the multi-region editing system 106 grounding extracted regions in a digital image in accordance with one or more embodiments.

Indeed, in certain cases, the multi-region editing system 106 grounds regions extracted from natural language text input to establish associations between text segments of the natural language text input and regions of the digital image. Indeed, while generating a style-region mapping identifies which text segments of natural language text input correspond to an image region, the style-region mapping does not indicate where those identified regions are to be found within the particular digital image to be modified or even if they are included in the digital image at all. In other words, the style-region mapping does not link the regions indicated in the natural language text input to the digital image to be modified. Thus, in some implementations, the multi-region editing system 106 grounds the regions extracted from the natural language text input in the digital image to establish such a link.

As shown in FIG. 4, the multi-region editing system 106 provides the digital image 402 to be modified and region text 404 to a text grounding model 406. The region text 404 includes text indicating an image region to be modified. For instance, in some cases, the region text 404 includes text targeting a region of the digital image 402 for modification. In some embodiments, the region text 404 includes a text segment extracted from natural language text input received for modifying the digital image 402. Indeed, in some cases, the region text 404 includes a text segment from a style-region mapping generated from natural language text input as described above with reference to FIG. 3.

In one or more embodiments, a text grounding model includes a computer-implemented model that determines a region of a digital image that corresponds to a text segment. In particular, in some embodiments, a text grounding model includes a computer-implemented model that determines a region of a digital image that is targeted or otherwise indicated by a text segment. For instance, in some cases, a text grounding model determines a region of a digital image that corresponds to a text segment based on the content of the text segment (e.g., a label or description included in the text segment). In certain implementations, a text grounding model generates one or more bounding boxes for the region of the digital image that is determined to correspond to the text segment. Indeed, as shown in FIG. 4, the multi-region editing system 106 uses the text grounding model 406 to generate a bounding box 408 for the region of the digital image 402 that is targeted by the region text 404.

In one or more embodiments, the text grounding model 406 includes an object detection model. For instance, in some cases, the text grounding model 406 includes an open-set object detection model. In some embodiments, the multi-region editing system 106 derives the text grounding model 406 as an open-set object detection model by introducing language to a closed-set object detection model for open-concept generalization. To illustrate, in some cases, the multi-region editing system 106 trains the text grounding model 406 on one or more large-scale datasets, such as one or more object detection datasets, one or more grounding datasets that link objects (e.g., annotated with bounding boxes) within digital images to labels or other text descriptions, and/or one or more caption datasets that include captions describing the content of corresponding digital images.

In one or more embodiments, the text grounding model 406 includes a neural network architecture, such as a neural network having a dual-encoder-single-decoder architecture. To illustrate, in some cases, the text grounding model 406 includes an image backbone for (e.g., multi-scale) image feature extraction, a text backbone for text feature extraction, a feature enhancer for image and text feature fusion, a language-guided query selection module for query initialization, and a cross-modality decoder for box refinement. In some embodiments, the feature enhancer includes one or more self-attention (e.g., deformable self-attention) layers that process the text features and/or image features, one or more cross-attention layers (e.g., an image-to-text cross attention layer and a text-to-image cross-attention layer) that fuse the outputs of the self-attention layer(s), and one or more feed-forward neural network layers that update the text features and the image features to include cross-modality features using the outputs of the cross-attention layer(s). In some cases, the cross-modality decoder also includes one or more self-attention layers, one or more cross-attention layers (e.g., an image cross-attention layer and a text cross-attention layer) and one or more feed-forward network layers from which output bounding boxes are generated. Various architectures, however, are used in various implementations.

Thus, as shown in FIG. 4, the multi-region editing system 106 uses the text grounding model 406 to output the bounding box 408 for the region of the digital image 402 indicated by the region text 404. Though FIG. 4 illustrates the multi-region editing system 106 inputting the region text 404 by itself to generate the bounding box 408, the multi-region editing system 106 inputs all text segments indicating an image region extracted from the corresponding natural language text input to generate corresponding bounding boxes in some implementations. To illustrate, in some cases, the multi-region editing system 106 combines (e.g., concatenates) the text segments indicating image regions and provides the combined result to the text grounding model 406. The multi-region editing system 106 uses the text grounding model 406 to score text-object pairs and chooses the objects with the largest scores as the objects that correspond to the text segments.

Additionally, as shown in FIG. 4, the multi-region editing system 106 provides the bounding box 408 and the digital image 402 to a segmentation model 410. In one or more embodiments, a segmentation model includes a computer-implemented model, such as a computer-implemented neural network, that partitions a digital image into one or more regions. In particular, in some embodiments, a segmentation model includes a neural network that generates a segmentation mask for one or more regions of a digital image. To illustrate, in some cases, a segmentation model analyzes a digital image and a bounding box for a region of the digital image and generates a segmentation mask for the region based on the analysis.

As further shown, the multi-region editing system 106 uses the segmentation model 410 to generate a segmentation mask 412 from the bounding box 408 and the digital image 402. In particular, the multi-region editing system 106 generates the segmentation mask 412 for the region of the digital image 402 that is targeted by the region text 404.

In one or more embodiments, a segmentation mask includes an identification of pixels in an image that represent an object. In particular, in some embodiments, a segmentation mask includes an image filter useful for partitioning a digital image into separate regions. For example, in some cases, a segmentation mask includes a filter that corresponds to a digital image (e.g., a foreground image) that identifies a region of the digital image (i.e., pixels of the digital image) belonging to a foreground object and a region of the digital image belonging to a background. It should be understood, however, that the multi-region editing system 106 generates segmentation masks corresponding to various image regions in various implementations. In some instances, a segmentation mask includes a map of the digital image that has an indication for each pixel of whether the pixel is part of a particular region or not. For instance, in some embodiments, the indication comprises a binary indication (a 1 for pixels belonging to the region and a zero for pixels not belonging to the region. In alternative implementations, the indication comprises a probability (e.g., a number between 1 and 0) that indicates the likelihood that a pixel belongs to the region. In such implementations, the closer the value is to 1, the more likely the pixel belongs to the region and vice versa.

Thus, by implementing the pipeline illustrated in FIG. 4, the multi-region editing system 106 grounds the region text 404 in the digital image 402. In particular, by generating a bounding box via the text grounding model 406 for a text segment (i.e., a region text) indicating an image region, the multi-region editing system 106 establishes a link between a text segment from natural language input and a region of a digital image targeted by the text segment.

As mentioned, certain cases involve providing multiple region texts to the text grounding model 406 to generate corresponding bounding boxes. Thus, in some cases, the multi-region editing system 106 provides the bounding boxes to the segmentation model 410 to generate corresponding segmentation masks. The multi-region editing system 106 provides the bounding boxes together in some embodiments and one at a time in other embodiments.

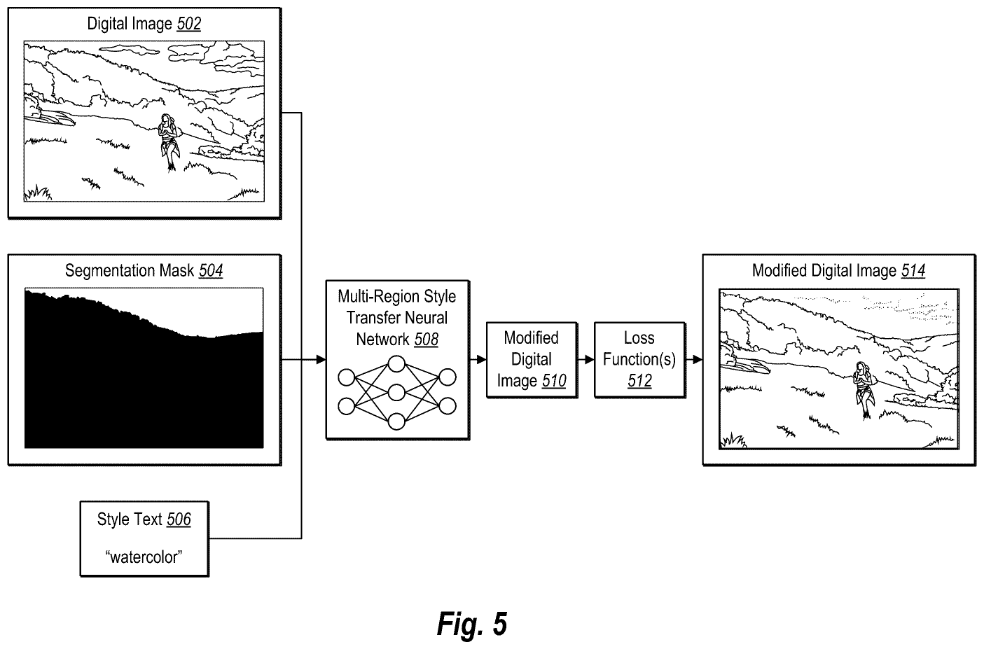

As mentioned, in one or more embodiments, the multi-region editing system 106 performs localized style transfer to modify a digital image by incorporating various styles within various regions portrayed therein. In particular, in some embodiments, the multi-region editing system 106 modifies the regions using a multi-region style transfer neural network. FIG. 5 illustrates the multi-region editing system 106 modifying a region of a digital image using a multi-region style transfer neural network in accordance with one or more embodiments.

In one or more embodiments, a neural network includes a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, a diffusion neural network, or a multi-layer perceptron. In some embodiments, a neural network includes a combination of neural networks or neural network components.

In one or more embodiments, a multi-region style transfer neural network includes a computer-implemented neural network that generates a modified digital image from a digital image by modifying one or more regions of the digital image via localized style transfer. In particular, in some embodiments, a multi-region style transfer neural network includes a neural network that modifies a region of a digital image by incorporating another style within the region. Indeed, the multi-region style transfer neural network modifies an initial style of the region to incorporate another style. In some cases, a multi-region style transfer neural network modifies multiple regions of a digital image to incorporate a different style within each region. In certain instances, as will be discussed below a multi-region style transfer neural network modifies a region of a digital image via an iterative process.

As shown in FIG. 5, the multi-region editing system 106 provides a digital image 502, a segmentation mask 504, and style text 506 to a multi-region style transfer neural network 508. The segmentation mask 504 includes a segmentation mask generated for a region of the digital image 502 as described above with reference to FIG. 4. Additionally, the style text 506 includes text indicating a style to use in modifying a region of the digital image 502. For instance, in some cases, the style text 506 includes text indicating a style to use in modifying the region that corresponds to the segmentation mask 504. In some embodiments, the style text 506 includes a text segment extracted from natural language text input received for modifying the digital image 502. Indeed, in some cases, the style text 506 includes a text segment from a style-region mapping generated from natural language text input as described above with reference to FIG. 3. In certain embodiments, the multi-region editing system 106 uses the style-region mapping to determine that the style indicated by the style text 506 is mapped to the region of the digital image 502 that corresponds to the segmentation mask 504. Indeed, in some cases, the multi-region editing system 106 uses the style-region mapping associate the style text 506 with the segmentation mask 504.

In one or more embodiments, the multi-region style transfer neural network 508 includes a convolutional neural network. In some cases, the multi-region style transfer neural network 508 includes a diffusion neural network or other generative neural network.

As FIG. 5 illustrates, the multi-region editing system 106 uses the multi-region style transfer neural network 508 to generate a modified digital image 510 from the digital image 502, the segmentation mask 504, and the style text 506. In some cases, the modified digital image 510 includes a digital image in which the region of the digital image 502 corresponding to the segmentation mask 504 and the style text 506 is partially modified. Indeed, in some cases, the modified digital image 510 includes a modified version of the digital image 502 in which the modification to the region is incomplete.

Indeed, as mentioned, in some cases, the multi-region editing system 106 uses the multi-region style transfer neural network 508 to modify the region of the digital image 502 via an iterative process. To illustrate, as shown in FIG. 5, the multi-region editing system 106 uses one or more loss functions 512 to update/modify one or more of the parameters of the multi-region style transfer neural network 508 based on the modified digital image 510. The multi-region editing system 106 uses the multi-region style transfer neural network 508 with the updated parameter(s) to generate an additional modified digital image (e.g., a modified version of the modified digital image 510). The multi-region editing system 106 repeats this process of updating the network parameters and generating another modified digital image to produce a modified digital image 514 in which the modification to the targeted region is complete. In some cases, the multi-region editing system 106 performs a particular number of iterations. In some instances, the multi-region editing system 106 performs iterations until some threshold has been met (e.g., a target loss has been reached).

As such, in one or more embodiments, the multi-region editing system 106 learns the parameters of the multi-region style transfer neural network 508 at inference time rather during a training process. In particular, in some instances, the multi-region editing system 106 employs the multi-region style transfer neural network 508 without a pre-training process. In doing so, the multi-region editing system 106 reduces the computing resources used to modify a digital image via local style transfer. Indeed, while many conventional systems employ models that demand a significant amount of computational resources for pre-training, the multi-region editing system 106 uses a model that iteratively learns to modify a digital image during inference.

In one or more embodiments, the multi-region editing system 106 uses, as the one or more loss functions 512, a directional loss function. For instance, in some embodiments, the multi-region editing system 106 uses the directional loss function defined as follows:

$$\overline{{L}_{d ι r}} = 1 - \frac{Δ T \cdot \overline{Δ I}}{\vert Δ T \vert \vert \overline{Δ I} \vert} \qquad ( 1 )$$

In equation 1, ΔT=E_{T}(t_{sty})−E_{T}(t_{src}) and ΔI=E_{I}(I_{cs}⊙Mᵢ)−E_{I}(I_{c}⊙Mᵢ) where E_{T} represents a text encoder, E_{I} represents an image decoder, t_{sty} represents style text, t_{src} represents source text, I_{c} represents the content image (e.g., the input digital image), I_{cs} represents the stylized image (e.g., the modified digital image), and Mᵢ represents a segmentation mask. In some cases, the multi-region editing system 106 uses the masked directional loss function defined by equation 1 to align the difference between text and image embeddings in the encoding space. Further, in some cases, the multi-region editing system 106 incorporates the segmentation mask to constrain the style transfer process to the region being targeted for modification. In one or more embodiments, the multi-region editing system 106 sets the source text t_{src} to “a Photo.”

In some embodiments, the multi-region editing system 106 uses, as one of the one or more loss functions 512, a masked patch loss function. For instance, in some cases, the multi-region editing system 106 uses the masked patch loss function defined as follows:

$$\overline{{L}_{patch}} = {\sum }_{j = 1}^{c} {I}_{dir , j} \qquad ( 2 )$$

In some embodiments, the multi-region editing system 106 uses the masked patch loss function to further align the semantics of the stylized image with the target style indicated by the style text by applying L_{dir} to a number of crops in the stylized image. To illustrate, in some cases, the multi-region editing system 106 samples patches from the segmentation mask by randomly or semi-randomly selecting (left, top) coordinates and extract patches of size pₛ×pₛ. These patches are represented as I_{c,j} for the content patch and I_{cs,j} for the stylized image patch. In some instances, the multi-region editing system 106 further determines a crop for the segmentation mask, represented as M_{i,j}, using the same parameters to provide consistency in style transfer at the segmentation boundaries. The multi-region editing system 106 performs a dot product operation on content crop patch and the stylized image patch with the segmentation mask patch. In certain cases, the multi-region editing system 106 also applies random or semi-random geometric augmentations to the patches.

Thus, in some cases, the multi-region editing system 106 obtains C crops I_{cs,j}, I_{c,j}, M_{i,j} for j∈{1,2,3, . . . , C} and L_{dir,j} becomes a modified version of equation 1 that incorporates ΔIⱼ rather than ΔI, and ΔIⱼ incorporates I_{cs,j} and I_{c,j} rather than I_{cs} and I_{c}, respectively.

In certain cases, the multi-region editing system 106 uses, as one of the one or more loss functions 512, a content loss function. For instance, in some instances, the multi-region editing system 106 uses the content loss function defined as follows:

$${L}_{content} = {‖ VGG ( {I}_{c} ) - V GG ( {I}_{c s} ) ‖}_{2} \qquad ( 3 )$$

As indicated by equation 3, the multi-region editing system 106 uses a pre-trained visual geometry group (VGG) network to determine to content loss function in some embodiments. In some cases, however, the multi-region editing system 106 uses another convolutional neural network architecture. In some embodiments, the multi-region editing system 106 uses the content loss function to ensure that the existing content in the original image is preserved in the final stylized output image (e.g., the modified digital image 514).

In some implementations, the multi-region editing system 106 uses, as one of the one or more loss functions 512, an identity loss function, such as the identity loss function defined as follows:

$$\overline{{L}_{ι d}} = {‖ {I}_{c s} ⊙ ( 1 - {M}_{i} ) - {I}_{c} ⊙ ( 1 - {M}_{i} ) ‖}_{1} \qquad ( 4 )$$

In some cases, the multi-region editing system 106 uses the identity loss function to preserve the regions outside the segmentation mask Mᵢ in their original content image state. In some instances, the multi-region editing system 106 uses the identity loss function as a Li function to measure the absolute differences between the content image and the stylized image for these regions. In particular, the multi-region editing system 106 uses the identity loss function to ensure that the information and visual characteristics of the content image outside the targeted segmentation mask remain unaltered and effectively transferred to the stylized output.

In one or more embodiments, the multi-region editing system 106 uses, as one of the one or more loss functions 512, a relational loss function, such as the relational loss function defined as follows:

$$\overline{{L}_{rel}} = {L}_{rel} ( {I}_{c s} ⊙ {M}_{i} ) \qquad ( 5 )$$

In one or more embodiments, the multi-region editing system 106 uses the relational loss function to ensure that the relationship between the stylized image and a style basis is similar to the relationship between the target style text description and the same style basis. In some cases, the multi-region editing system 106 creates the style basis using one or more embeddings of a style template. In some instances, to confine the loss's influence to the specific local area being modified, the multi-region editing system 106 applies the relational loss function to cropped portions of the image obtained from the targeted region.

In certain implementations, the multi-region editing system 106 uses at least two of the loss functions described above as the one or more loss functions 512. In particular, in some cases, the multi-region editing system 106 combines two or more of the loss functions. For instance, in some cases, the multi-region editing system 106 combines the loss functions described above as follows:

$$\overline{{L}_{total}} = \overline{{λ}_{d} {L}_{d ι r}} + \overline{{λ}_{p} {L}_{patch}} + \overline{{λ}_{c} {L}_{content}} + \overline{{λ}_{ι d} {L}_{ι d}} + \overline{{λ}_{rel} {L}_{rel}} \qquad ( 6 )$$

Thus, in one or more embodiments, the multi-region editing system 106 uses the combined loss function of equation 6 to evaluate the modified digital image produced by the multi-region style transfer neural network 508 and update the network parameters over a plurality of iterations. Upon completing the plurality of iterations, the multi-region style transfer neural network 508 produces the modified digital image 514.

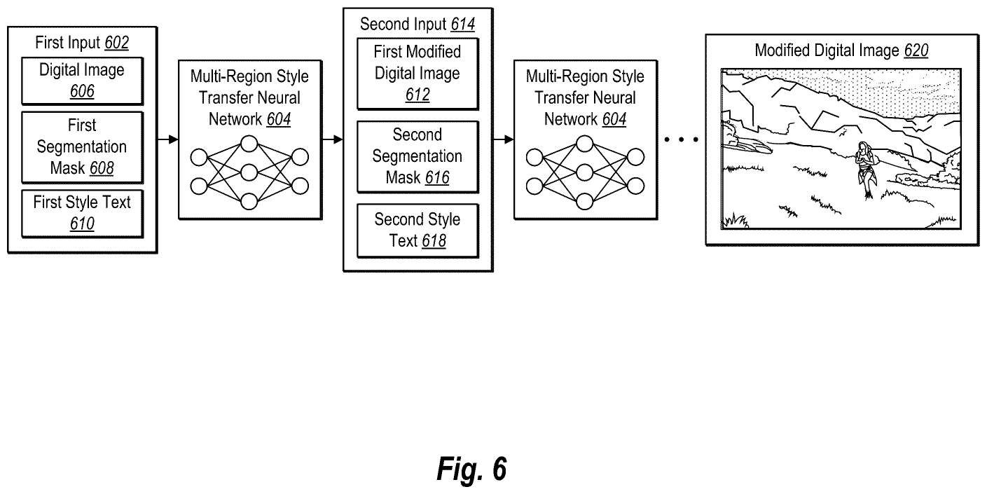

As mentioned, in some cases, the multi-region editing system 106 uses a multi-region style transfer neural network to modify multiple regions of a digital image. FIG. 6 illustrates the multi-region editing system 106 modifying multiple regions of a digital image in accordance with one or more embodiments.

As shown in FIG. 6, the multi-region editing system 106 provides first input 602 to a multi-region style transfer neural network 604. The first input 602 includes a digital image 606 to be modified, a first segmentation mask 608 corresponding to a first region of the digital image 606 to be modified, and a first style text 610 indicating a first style to be incorporated into the first region. The multi-region editing system 106 uses the multi-region style transfer neural network 604 to generate (e.g., over a first set of iterations) a first modified digital image 612 from the first input 602. In particular, the multi-region editing system 106 generates the first modified digital image 612 by modifying the first region of the neural network 604 to incorporate the first style indicated by the first style text 610.

As further shown, the multi-region editing system 106 provides second input 614 to the multi-region style transfer neural network 604. The second input 614 includes the first modified digital image 612, a second segmentation mask 616 corresponding to a second region of the digital image 606 to be modified, and a second style text 618 indicating a second style to be incorporated into the second region.

Though not shown, the multi-region editing system 106 uses the multi-region style transfer neural network 604 to generate (e.g., over a second set of iterations) a second modified digital image form the second input 614. Indeed, the multi-region editing system 106 uses the neural network 604 to generate the second modified digital image by modifying the first modified digital image 612. In particular, the multi-region editing system 106 generates the second modified digital image by modifying the second region within the first modified digital image 612 such that the second modified digital image includes the first region as modified and the second region as modified. Thus, in some cases, the multi-region editing system 106 uses the multi-region style transfer neural network to sequentially modify each targeted region (e.g., over a set of iterations) until the final modification output (e.g., the modified digital image 620) is obtained.

Turning now to FIG. 7, additional detail will now be provided regarding various components and capabilities of the multi-region editing system 106. FIG. 7 illustrates the multi-region editing system 106 implemented by the computing device 700 (e.g., the server device(s) 102 and/or one of the client devices 110a-110n discussed above with reference to FIG. 1). Additionally, the multi-region editing system 106 is part of the image editing system 104. As shown, in one or more embodiments, the multi-region editing system 106 includes, but is not limited to, a style-region mapping engine 702, a text grounding engine 704, an image modification engine 706, and data storage 708 (which includes a large language model 710, a text grounding model 712, a segmentation model 714, and a multi-region style transfer neural network 716.)

As just mentioned, and as illustrated in FIG. 7, the multi-region editing system 106 includes the style-region mapping engine 702. In one or more embodiments, the style-region mapping engine 702 generates a style-region mapping from natural language text input. For instance, in some cases, the style-region mapping engine 702 uses a large language model to extract text segments indicating regions of a digital image to be modified and styles to use in modifying those regions and generates a style-region mapping based on the extracted text.

Additionally, as shown in FIG. 7, the multi-region editing system 106 includes the text grounding engine 704. In one or more embodiments, the text grounding engine 704 grounds text from natural language text input in a digital image received for modification. In particular, in some cases, the text grounding engine 704 grounds text segments indicating image regions in the digital image. For instance, in some cases, the text grounding engine 704 employs a text grounding model to generate bounding boxes for regions of the digital image that correspond to the text segments. Further, the text grounding engine 704 uses a segmentation model to generate segmentation masks for the regions based on the bounding boxes.

As shown in FIG. 7, the multi-region editing system 106 further includes the image modification engine 706. In one or more embodiments, the image modification engine 706 modifies a digital image by modifying various regions of the digital image to incorporate various styles via local style transfer. For instance, in some cases, the image modification engine 706 employs a multi-region style transfer neural network to modify the regions of the digital image. In some cases, the image modification engine 706 modifies each region over a plurality of iterations. In some cases, the image modification engine 706 further modifies the regions sequentially, such that the modification output for one region is used in generating the modification output for the next region.

As further shown in FIG. 7, the multi-region editing system 106 includes data storage 708. In particular, data storage 708 includes the large language model 710, the text grounding model 712, the segmentation model 714, and the multi-region style transfer neural network 716.

Each of the components 702-716 of the multi-region editing system 106 optionally include software, hardware, or both. For example, in some cases, the components 702-716 include one or more instructions stored on a computer-readable storage medium and executable by processors of one or more computing devices, such as a client device or server device. When executed by the one or more processors, the computer-executable instructions of one or more embodiments of the multi-region editing system 106 cause the computing device(s) to perform the methods described herein. Alternatively, in some instances, the components 702-716 include hardware, such as a special-purpose processing device to perform a certain function or group of functions. Alternatively, in certain implementations, the components 702-716 of the multi-region editing system 106 include a combination of computer-executable instructions and hardware.

Furthermore, in one or more embodiments, the components 702-716 of the multi-region editing system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 702-716 of the multi-region editing system 106 are implemented as a stand-alone application, such as a desktop or mobile application. Furthermore, in some cases, the components 702-716 of the multi-region editing system 106 are implemented as one or more web-based applications hosted on a remote server device. Alternatively, or additionally, the components 702-716 of the multi-region editing system 106 are implemented in a suite of mobile device applications or “apps.” For example, in one or more embodiments, the multi-region editing system 106 comprises or operates in connection with digital software applications such as ADOBE® PHOTOSHOP®, ADOBE® ILLUSTRATOR®, or ADOBE® CREATIVE CLOUD®. The foregoing are either registered trademarks or trademarks of Adobe Inc. in the United States and/or other countries.

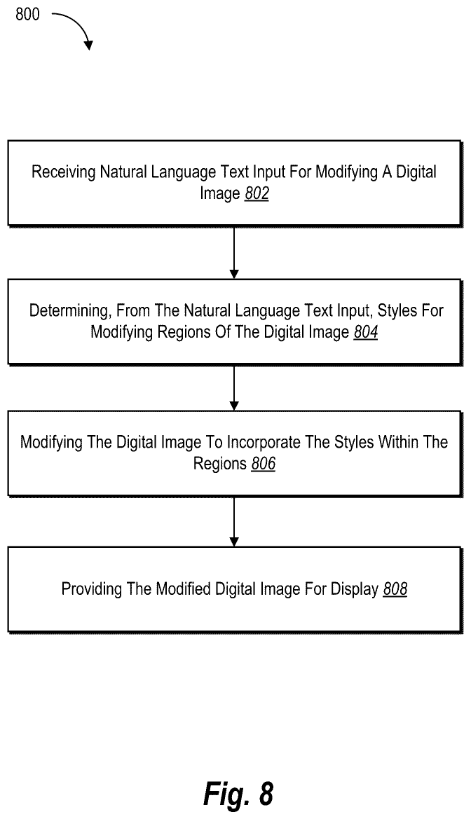

FIGS. 1-7, the corresponding text, and the examples provide a number of different methods, systems, devices, and non-transitory computer-readable media of the multi-region editing system 106. In addition to the foregoing, one or more embodiments are also described in terms of flowcharts comprising acts for accomplishing the particular result, as shown in FIG. 8. In one or more embodiments, FIG. 8 is performed with more or fewer acts. Further, in some embodiments, the acts are performed in different orders. Additionally, in some cases, the acts described herein are repeated or performed in parallel with one another or in parallel with different instances of the same or similar acts.

FIG. 8 illustrates a flowchart of a series of acts 800 for modifying multiple regions of a digital image via localized style transfer in accordance with one or more embodiments. FIG. 8 illustrates acts according to one embodiment, but alternative embodiments omit, add to, reorder, and/or modify any of the acts shown in FIG. 8. In some implementations, the acts of FIG. 8 are performed as part of a computer-implemented method. Alternatively, in some embodiments, a non-transitory computer-readable medium stores instructions thereon that, when executed by at least one processor, cause the at least one processor to perform operations comprising the acts of FIG. 8. In some embodiments, a system performs the acts of FIG. 8. For example, in some cases, a system includes one or more memory devices. The system further includes one or more processors coupled to the one or more memory devices that cause the system to perform operations comprising the acts of FIG. 8.

The series of acts 800 includes an act 802 for receiving natural language text input for modifying a digital image. For example, in one or more embodiments, the act 802 involves receiving natural language text input for modifying a digital image from a client device.

The series of acts 800 also includes an act 804 for determining, from the natural language text input, styles for modifying regions of the digital image. For instance, in some embodiments, the act 804 involves determining, from the natural language text input, a first style for modifying a first region of the digital image and a second style for modifying a second region of the digital image.

In one or more embodiments, the multi-region editing system 106 generates a style-region mapping prompt that includes the natural language text input and an example style-region mapping that corresponds to an example natural language text input. Accordingly, in some instances, determining, from the natural language text input, the first style for modifying the first region and the second style for modifying the second region comprises determining, using a large language model and from the style-region mapping prompt, a style-region mapping that maps the first style to the first region and maps the second style to the second region.

Additionally, the series of acts 800 includes an act 806 for modifying the digital image to incorporate the styles within the regions. To illustrate, in some cases, the act 806 involves modifying, using a multi-region style transfer neural network, the digital image by incorporating the first style within the first region and incorporating the second style within the second region. In one or more embodiments, modifying the digital image using the multi-region style transfer neural network comprises modifying the digital image using a convolutional neural network.

In one or more embodiments, modifying, using the multi-region style transfer neural network, the digital image by incorporating the first style within the first region and incorporating the second style within the second region comprises: generating, using the multi-region style transfer neural network and from the digital image, a first modified digital image that incorporates the first style within the first region; and generating, using the multi-region style transfer neural network and from the first modified digital image, a second modified digital image that incorporates the second style within the second region while maintaining the first style within the first region. In some embodiments, generating the first modified digital image from the digital image using the multi-region style transfer neural network comprises modifying the digital image using the multi-region style transfer neural network over a plurality of iterations by modifying parameters of the multi-region style transfer neural network for one or more iterations using a plurality of loss functions. Further, in some cases, modifying the parameters of the multi-region style transfer neural network for the one or more iterations using the plurality of loss functions comprises modifying the parameters for the one or more iterations using at least two of a masked directional loss function, a masked patch loss function, a content loss function, an identity loss function, or a relational loss function.

In some instances, the multi-region editing system 106 generates, using a segmentation model, a first segmentation mask for the first region of the digital image and a second segmentation mask for the second region of the digital image. As such, in certain embodiments, modifying the digital image using the multi-region style transfer neural network comprises modifying the digital image using the multi-region style transfer neural network, the first segmentation mask, and the second segmentation mask. Additionally, in some cases, the multi-region editing system 106 generates, using a text grounding model, a first bounding box for the first region of the digital image and a second bounding box for the second region of the digital image. Thus, in one or more embodiments, generating, using the segmentation model, the first segmentation mask and the second segmentation mask comprises generating, using the segmentation model, the first segmentation mask from the first bounding box and the second segmentation mask from the second bounding box.

The series of acts 800 further includes an act 808 for providing the modified digital image for display. For example, in some instances, the act 808 involves providing the modified digital image for display on a graphical user interface of a client device.

To provide an illustration, in one or mor embodiments, the multi-region editing system 106 extracts, using a large language model and from natural language text input, a first style for modifying a first region of a digital image and a second style for modifying a second region of the digital image; determines, using a segmentation model, a first segmentation mask for the first region of the digital image and a second segmentation mask for the second region; generates, using a multi-region style transfer neural network and from the digital image and the first segmentation mask, a first modified digital image that incorporates the first style within the first region; and generates, using the multi-region style transfer neural network and from the first modified digital image and the second segmentation mask, a second modified digital image that incorporates the second style within the second region.

In some embodiments, generating, using the multi-region style transfer neural network, the first modified digital image from the digital image comprises modifying, using the multi-region style transfer neural network, the digital image over a first set of iterations to generate the first modified digital image; and generating, using the multi-region style transfer neural network, the second modified digital image from the first modified digital image comprises modifying, using the multi-region style transfer neural network, the first modified digital image over a second set of iterations to generate the second modified digital image. Further, in some embodiments, modifying, using the multi-region style transfer neural network, the digital image over the first set of iterations comprises: generating a modified digital image from the digital image using the multi-region style transfer neural network with a set of parameters; modifying the set of parameters of the multi-region style transfer neural network using the modified digital image and a plurality of loss functions; and generating an additional modified digital image from the modified digital image using the multi-region style transfer neural network with the modified set of parameters. In some instances, modifying the set of parameters of the multi-region style transfer neural network using the plurality of loss functions comprises modifying the set of parameters of the multi-region style transfer neural network using a masked directional loss function, a masked patch loss function, a content loss function, an identity loss function, and a relational loss function.

In one or more embodiments, extracting, using the large language model, the first style for modifying the first region of the digital image and the second style for modifying the second region of the digital image comprises generating, using the large language model, a style-region mapping that maps the first style to the first region and maps the second style to the second region; and the multi-region editing system 106 further determines to use the first segmentation mask for generating the first modified digital image to incorporate the first style within the first region based on determining that the style-region mapping maps the first style to the first region.

In some embodiments, extracting, using the large language model and from the natural language text input, the first style for modifying the first region of the digital image comprises extracting, using the large language model and from the natural language text input, a first text segment indicating the first region of the digital image and a second text segment indicating the first style for modifying the first region.

Additionally, in some cases, the multi-region editing system 106 generates, using a text grounding model, an indication of an association between a text segment included in the natural language text input and the first region of the digital image; and determining, using the segmentation model, the first segmentation mask for the first region of the digital image comprises determining, using the segmentation model, the first segmentation mask for the first region of the digital image based on the indication of the association between the text segment and the first region. In certain embodiments, generating, using the text grounding model, the indication of the association between the text segment and the first region of the digital image includes generating, using the text grounding model, a bounding box around the first region of the digital image based on the text segment.

To provide another illustration, in some implementations, the multi-region editing system 106 receives natural language text input for modifying a digital image; determines, from the natural language text input, a first style for modifying a first region of the digital image and a second style for modifying a second region of the digital image; modifies, using a multi-region style transfer neural network, the digital image by incorporating the first style within the first region and incorporating the second style within the second region; and provides the modified digital image for display on a graphical user interface of a client device.

In some embodiments, modifying, using the multi-region style transfer neural network, the digital image by incorporating the first style within the first region and incorporating the second style within the second region comprises modifying, using the multi-region style transfer neural network, the digital image by incorporating the first style within the first region and incorporating the second style within the second region while maintaining an initial style within a third region of the digital image. In some cases, receiving the natural language text input for modifying the digital image comprises receiving the natural language text input having a single string of text indicating a plurality of image regions to modify and a plurality of image styles for modifying the plurality of image regions. Further, in some implementations, modifying, using the multi-region style transfer neural network, the digital image by incorporating the first style within the first region and incorporating the second style within the second region comprises modifying the digital image over a plurality of modification iterations by using, for one or more modification iterations, the multi-region style transfer neural network having updated parameters determined using one or more loss functions.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that is configured to perform one or more of the processes described above in some embodiments. One will appreciate that one or more computing devices, such as the computing device 900, represent the computing devices described above (e.g., the server device(s) 102 and/or the client devices 110a-110n) in some implementations. In one or more embodiments, the computing device 900 is a mobile device (e.g., a mobile telephone, a smartphone, a PDA, a tablet, a laptop, a camera, a tracker, a watch, a wearable device). In some embodiments, the computing device 900 is a non-mobile device (e.g., a desktop computer or another type of client device). Further, in certain embodiments, the computing device 900 is a server device that includes cloud-based processing and storage capabilities.

As shown in FIG. 9, the computing device 900 includes one or more processor(s) 902, memory 904, a storage device 906, input/output interfaces 908 (or “I/O interfaces 908”), and a communication interface 910, which are communicatively coupled by way of a communication infrastructure (e.g., bus 912). While the computing device 900 is shown in FIG. 9, the components illustrated in FIG. 9 are not intended to be limiting. Additional or alternative components are used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 retrieve (or fetch) the instructions from an internal register, an internal cache, memory 904, or a storage device 906 and decode and execute them in some implementations.

The computing device 900 includes memory 904, which is coupled to the processor(s) 902. In certain cases, the memory 904 is used for storing data, metadata, and programs for execution by the processor(s). In some instances, the memory 904 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 904 includes internal or distributed memory.

The computing device 900 includes a storage device 906 including storage for storing data or instructions. As an example, and not by way of limitation, in some cases, the storage device 906 includes a non-transitory storage medium described above. In some embodiments, the storage device 906 includes a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. In one or more embodiments, these I/O interfaces 908 include a mouse, keypad or a keyboard, a touch screen, camera, optical scanner, network interface, modem, other known I/O devices or a combination of such I/O interfaces 908. In some cases, the touch screen is activated with a stylus or a finger.

In one or more embodiments, the I/O interfaces 908 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. In some cases, the graphical data is representative of one or more graphical user interfaces and/or any other graphical content that serves a particular implementation.

The computing device 900 further includes a communication interface 910. In some cases, the communication interface 910 includes hardware, software, or both. The communication interface 910 provides one or more interfaces for communication (such as, for example, packet-based communication) between the computing device and one or more other computing devices or one or more networks. As an example, and not by way of limitation, in some cases, communication interface 910 includes a network interface controller (NIC) or network adapter for communicating with an Ethernet or other wire-based network or a wireless NIC (WNIC) or wireless adapter for communicating with a wireless network, such as a WI-FI. The computing device 900 further includes a bus 912. In some cases, the bus 912 includes hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving natural language text input for modifying a digital image;
determining, from the natural language text input, a first style for modifying a first region of the digital image and a second style for modifying a second region of the digital image;
modifying, using a multi-region style transfer neural network, the digital image by incorporating the first style within the first region and incorporating the second style within the second region; and
providing the modified digital image for display on a graphical user interface of a client device.

2. The computer-implemented method of claim 1, wherein modifying, using the multi-region style transfer neural network, the digital image by incorporating the first style within the first region and incorporating the second style within the second region comprises:
generating, using the multi-region style transfer neural network and from the digital image, a first modified digital image that incorporates the first style within the first region; and
generating, using the multi-region style transfer neural network and from the first modified digital image, a second modified digital image that incorporates the second style within the second region while maintaining the first style within the first region.

3. The computer-implemented method of claim 2, wherein generating the first modified digital image from the digital image using the multi-region style transfer neural network comprises modifying the digital image using the multi-region style transfer neural network over a plurality of iterations by modifying parameters of the multi-region style transfer neural network for one or more iterations using a plurality of loss functions.

4. The computer-implemented method of claim 3, wherein modifying the parameters of the multi-region style transfer neural network for the one or more iterations using the plurality of loss functions comprises modifying the parameters for the one or more iterations using at least two of a masked directional loss function, a masked patch loss function, a content loss function, an identity loss function, or a relational loss function.

5. The computer-implemented method of claim 1,
further comprising generating a style-region mapping prompt that includes the natural language text input and an example style-region mapping that corresponds to an example natural language text input,
wherein determining, from the natural language text input, the first style for modifying the first region and the second style for modifying the second region comprises determining, using a large language model and from the style-region mapping prompt, a style-region mapping that maps the first style to the first region and maps the second style to the second region.

6. The computer-implemented method of claim 1,
further comprising generating, using a segmentation model, a first segmentation mask for the first region of the digital image and a second segmentation mask for the second region of the digital image,
wherein modifying the digital image using the multi-region style transfer neural network comprises modifying the digital image using the multi-region style transfer neural network, the first segmentation mask, and the second segmentation mask.

7. The computer-implemented method of claim 6,
further comprising generating, using a text grounding model, a first bounding box for the first region of the digital image and a second bounding box for the second region of the digital image,
wherein generating, using the segmentation model, the first segmentation mask and the second segmentation mask comprises generating, using the segmentation model, the first segmentation mask from the first bounding box and the second segmentation mask from the second bounding box.

8. The computer-implemented method of claim 1, wherein modifying the digital image using the multi-region style transfer neural network comprises modifying the digital image using a convolutional neural network.

9. A system comprising:
one or more memory devices; and
one or more processors coupled to the one or more memory devices that cause the system to perform operations comprising:
extracting, using a large language model and from natural language text input, a first style for modifying a first region of a digital image and a second style for modifying a second region of the digital image;
determining, using a segmentation model, a first segmentation mask for the first region of the digital image and a second segmentation mask for the second region;
generating, using a multi-region style transfer neural network and from the digital image and the first segmentation mask, a first modified digital image that incorporates the first style within the first region; and
generating, using the multi-region style transfer neural network and from the first modified digital image and the second segmentation mask, a second modified digital image that incorporates the second style within the second region.

10. The system of claim 9, wherein:
generating, using the multi-region style transfer neural network, the first modified digital image from the digital image comprises modifying, using the multi-region style transfer neural network, the digital image over a first set of iterations to generate the first modified digital image; and
generating, using the multi-region style transfer neural network, the second modified digital image from the first modified digital image comprises modifying, using the multi-region style transfer neural network, the first modified digital image over a second set of iterations to generate the second modified digital image.

11. The system of claim 10, wherein modifying, using the multi-region style transfer neural network, the digital image over the first set of iterations comprises:
generating a modified digital image from the digital image using the multi-region style transfer neural network with a set of parameters;
modifying the set of parameters of the multi-region style transfer neural network using the modified digital image and a plurality of loss functions; and
generating an additional modified digital image from the modified digital image using the multi-region style transfer neural network with the modified set of parameters.

12. The system of claim 11, wherein modifying the set of parameters of the multi-region style transfer neural network using the plurality of loss functions comprises modifying the set of parameters of the multi-region style transfer neural network using a masked directional loss function, a masked patch loss function, a content loss function, an identity loss function, and a relational loss function.

13. The system of claim 9, wherein:
extracting, using the large language model, the first style for modifying the first region of the digital image and the second style for modifying the second region of the digital image comprises generating, using the large language model, a style-region mapping that maps the first style to the first region and maps the second style to the second region; and
the operations further comprise determining to use the first segmentation mask for generating the first modified digital image to incorporate the first style within the first region based on determining that the style-region mapping maps the first style to the first region.

14. The system of claim 9, wherein extracting, using the large language model and from the natural language text input, the first style for modifying the first region of the digital image comprises extracting, using the large language model and from the natural language text input, a first text segment indicating the first region of the digital image and a second text segment indicating the first style for modifying the first region.

15. The system of claim 9, wherein:
the operations further comprise generating, using a text grounding model, an indication of an association between a text segment included in the natural language text input and the first region of the digital image; and
determining, using the segmentation model, the first segmentation mask for the first region of the digital image comprises determining, using the segmentation model, the first segmentation mask for the first region of the digital image based on the indication of the association between the text segment and the first region.

16. The system of claim 15, wherein generating, using the text grounding model, the indication of the association between the text segment and the first region of the digital image includes generating, using the text grounding model, a bounding box around the first region of the digital image based on the text segment.

17. A non-transitory computer-readable medium storing instructions thereon that, when executed by at least one processor, cause the at least one processor to perform operations comprising:
receiving natural language text input for modifying a digital image;
determining, from the natural language text input, a first style for modifying a first region of the digital image and a second style for modifying a second region of the digital image;
modifying, using a multi-region style transfer neural network, the digital image by incorporating the first style within the first region and incorporating the second style within the second region; and
providing the modified digital image for display on a graphical user interface of a client device.

18. The non-transitory computer-readable medium of claim 17, wherein modifying, using the multi-region style transfer neural network, the digital image by incorporating the first style within the first region and incorporating the second style within the second region comprises modifying, using the multi-region style transfer neural network, the digital image by incorporating the first style within the first region and incorporating the second style within the second region while maintaining an initial style within a third region of the digital image.

19. The non-transitory computer-readable medium of claim 17, wherein receiving the natural language text input for modifying the digital image comprises receiving the natural language text input having a single string of text indicating a plurality of image regions to modify and a plurality of image styles for modifying the plurality of image regions.

20. The non-transitory computer-readable medium of claim 17, wherein modifying, using the multi-region style transfer neural network, the digital image by incorporating the first style within the first region and incorporating the second style within the second region comprises modifying the digital image over a plurality of modification iterations by using, for one or more modification iterations, the multi-region style transfer neural network having updated parameters determined using one or more loss functions.
